(19) United States
(12) Patent Application Publication
(10) Pub. No.: US 2007/0149125 A1
(43) Pub. Date: Jun. 28, 2007

(54) Communication system and method

(76) Inventors: Duncan Bremner, Lochwinnoch (GB); Fraser Murray Edwards, Bishop's Stortford (GB)

Correspondence Address: PAUL, HASTINGS, JANOFSKY & WALKER LLP, P.O. BOX 919092, SAN DIEGO, CA, 92191-9092, US

(21) Appl. No.: 11/642,737

(22) Filed: Dec. 21, 2006

(30) Foreign Application Priority Data
Dec. 21, 2005 (GB) 0525996.5

(51) Int. Cl. H04B 7/00

(52) U.S. Cl. 455/41.2

(57) ABSTRACT

An ultra-wideband communication system 101 comprises a first device 103, such as a host device or server, which communicates with a second device 105, such as a portable device. The first device 103 comprises a memory 107 for storing data, for example a movie, that is to be downloaded to the second device 105. The first device 103 includes an ultra-wideband transmitter 109 for transmitting data over an air interface to an ultra-wideband receiver 113 in the second device. The effective data transfer rate between the first device 103 and the second device 105 is increased by concatenating two or more frequency sub-bands in a multi-band orthogonal frequency division multiplexing scheme, such that the transmitter 109 in the first device 103 is configured to behave like a number of transmitters, all bursting at the same time. In addition, means are provided for enabling the second device 105 to be located in a fixed positional relationship with the first device 103 during the data transfer operation. The range of the ultra-wideband transmission is reduced significantly to a distance “d” which, in combination with the securing of multiple UWB sub-bands, enables the data throughput to be increased significantly. The distance “d” is less than 30 cm, and preferably touching (without electrical contact).

### FIELD OF THE INVENTION

The invention relates to a communication system and method, and in particular to an ultra wideband (UWB) communication system and method for transferring a large amount of data, typically defined as greater than 1 GB, at high speed between a first communication device, such as a host device, and a second communication device, such as a portable device, in a wireless manner.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 meters.

Ultra-wideband uses very short impulses, often of the duration of nanoseconds (ns) or less, to modulate information across a very wide frequency spectrum (3.1-10.6 GHz is currently approved by Federal Communications Commission (FCC) in the United States). These pulses give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high speed wireless communication in the home or office environment, whereby the communicating devices are within a range of 20 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312 ns between sub-bands as an access method. Within each sub-band QPSK coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into four band groups, each having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc

Despite ultra-wideband having a large bandwidth that is capable of transmitting large amounts of data in a relatively short time, the ever increasing size of data downloads means that many applications will still experience problems or delays when copying large amounts of data between devices. For example, the transfer of video or music data between a first device (such as a wireless jukebox) and a second device (such as a personal computer) is sufficiently fast to enable video or music to be experienced wirelessly in real time. However, the transfer speed is less than acceptable for transferring a complete movie file between the first and second devices, which typically comprises transferring 10 to 40 GB of data.

It is known to increase the data rate by transmitting data symbols concurrently in a plurality of sub-bands. In other words, the data is encoded, interleaved and divided into two or more parallel bit streams for transmission concurrently in two or more of the sub-bands. However, such a system suffers from the disadvantage of requiring a plurality of transmitters and antennas, one for each of the concurrent sub-bands being used. The receiver also requires a plurality of antennas for receiving the concurrent information. Therefore, the cost of both the transmitting and receiving devices is increased due to duplication of antenna and radio stages.

The aim of the present invention is to provide an improved ultra-wideband communication system and method that is capable of transmitting bulk data over a short time period.

### SUMMARY OF THE INVENTION

According to a first aspect of the invention, there is provided a communication device for transmitting a data file to a portable device over an ultra-wideband communication system using multi-band orthogonal frequency division multiplexing, the multi-band orthogonal frequency division multiplexing organised as a plurality of frequency sub-bands. The communication device comprises means for concatenating two or more frequency sub-bands during a data transfer operation, and means for transmitting data via the two or more concatenated frequency bands to the portable device. The communication device also comprises means for enabling the portable device to be located in a predetermined positional relationship with respect to the communication device during a data transfer operation.

The concatenation of frequency sub-bands and the predetermined positional relationship between the two devices provides the advantage of enabling large volumes of data to be transmitted in a very short period of time.

According to a further aspect of the invention, there is provided a method of transmitting a data file between a communication device and a portable device in an ultra-wideband communication system using multi-band orthogonal frequency division multiplexing, the multi-band orthogonal frequency division multiplexing system organised into a plurality of frequency sub-bands. The method comprises the steps of concatenating two or more frequency bands, and transmitting data via the two or more concatenated frequency bands to the portable device. The method also comprises the step of positioning the portable device in a predetermined positional relationship to the communication device during the data transfer operation.

According to a further aspect of the invention, there is provided a portable device for use with a communication device as defined in the appended claims. The portable device comprises a receiver for receiving a signal comprising two or more concatenated frequency sub-bands, and processing means for processing the concatenated sub-bands.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

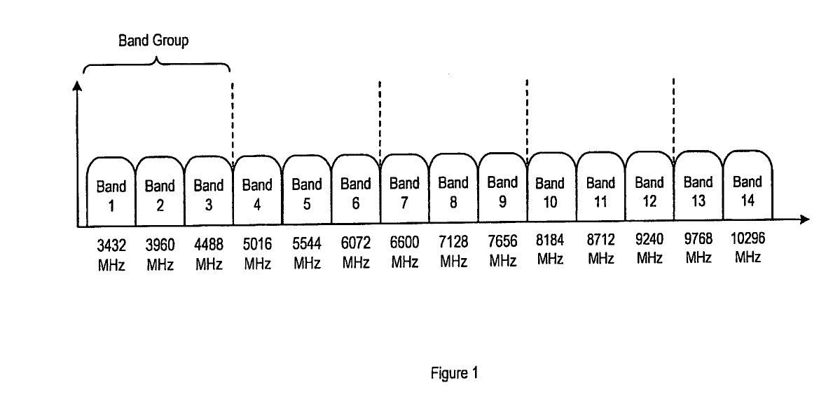

FIG. 2 shows an ultra-wideband communication system according to the present invention;

FIG. 3 shows the MBOA frequency spectrum of a MB-OFDM system when used in accordance with a first embodiment of the present invention;

FIG. 4 shows the MBOA frequency spectrum of a MB-OFDM system when used in accordance with a second embodiment of the present invention;

FIG. 5 shows an ultra-wideband communication system according to another aspect of the present invention;

FIGS. 6a and 6b show a typical application of an ultra-wideband communication system according to the present invention.

### DETAILED DESCRIPTION OF A PREFERRED EMBODIMENT OF THE PRESENT INVENTION

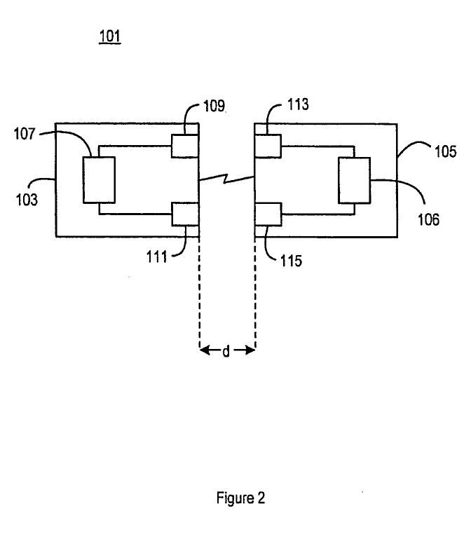

FIG. 2 shows a schematic view of an ultra-wideband communication system 101 according to the present invention. The ultra-wideband communication system 101 comprises a first communication device 103, such as a host device or server, which communicates with a second device 105, such as a portable device. It is noted that the second device 105 can be a “dumb” storage device such as a hard disc, or an “intelligent” device such a media player, mobile phone, or video playing device.

The first communication device 103 comprises a memory 107 for storing data that is to be downloaded to the second device 105. For example, the memory 107 can be adapted to store a catalogue or collection of movie films, audio tracks, photographic images, MP3 files, and so on. The first device 103 includes an ultra-wideband transmitter 109 for transmitting data over an air interface. Optionally, the first device 103 includes an ultra-wideband receiver 111 for receiving data from the second device 105, for example if data is to be uploaded from the second device 105 to the first device 103.

The second device 105 includes an ultra-wideband receiver 113 for receiving data received over the air interface from the first device 103, and a memory 106 for storing the received data. Optionally, the second device 105 includes an ultra-wideband transmitter 115 for transmitting data to the first device 103, for example if data is to be uploaded from the memory 106 of the second device 105 to the first device 103.

According to the invention, the effective data transfer rate between the first communication device 103 and the second device 105 is increased as follows.

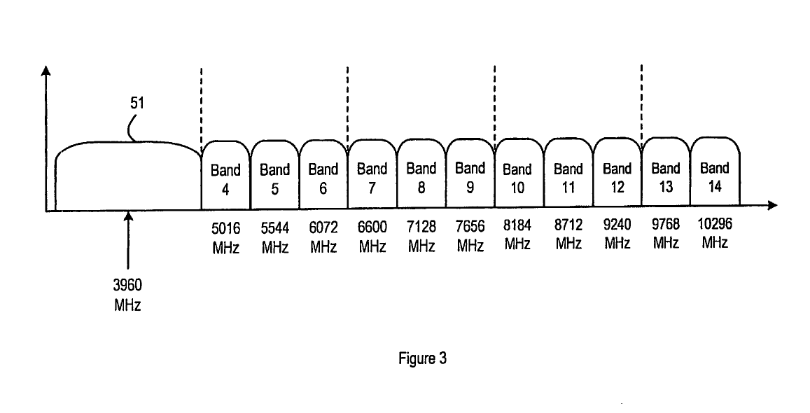

Firstly, the transmitter 109 in the first device 103 is configured to concatenate two or more sub-bands during a data transfer operation. For example, as shown in FIG. 3, the transmitter 109 in the first communication device 103 can be configured to concatenate sub-band 1, sub-band 2 and sub-band 3 from the first band group, such that a 1584 MHz base band signal 51 centred at 3960 MHz is employed for transmitting data. In this manner the data rate can be increased depending on the number of sub-bands that are concatenated. This has the effect of securing a plurality of UWB sub-bands in the immediate vicinity, thus enabling the UWB device of the present invention to secure increased bandwidth for enabling the data throughput to be increased.

Secondly, the first communication device 103 comprises means for enabling the second device 105 to be located in a predetermined positional relationship with respect to the first communication device 103 during a data transfer operation.

In this manner the first communication device 103 and the second device 105 are disposed in close proximity to one another during the data transfer operation, such that the range of the UWB transmission is reduced significantly to a distance “d”. In addition, the predetermined positional relationship between the first communication device 103 and the second device 105 enables the data rate to be increased. For example, the fact that the air interface between the first communication device 103 and the second device 105 is known means that certain communication protocols can be simplified or omitted. For example, channel estimation procedures become simplified because the first communication device 103 will know (or learn to know) the channel characteristics between itself and the second device 105, due to the fact that the second device 105 is located in the predetermined positional relationship. The predetermined positional relationship can also lead to a reduction in error rate, which also contributes to an increase in the effective data rate.

The close proximity of the first communication device 103 and the second device 105, coupled with the concatenation of multiple UWB sub-bands, enables the data throughput to be increased significantly. By “close proximity” it is meant that the distance “d” is less than 100 cm, and preferably less than 30 cm, or even touching (without electrical connection).

Thus, according to the invention the first communication device 103 widens the functional bandwidth by concatenating two or more frequency sub-bands. For example, as discussed above the invention can concatenate sub-band 1, sub-band 2 and sub-band 3, which are adjacent frequency sub-bands within a band group of the multi-band orthogonal frequency division multiplexing system. Alternatively, the invention can concatenate sub-bands from adjacent band groups, for example sub-band 2, sub-band 3 and sub-band 4.

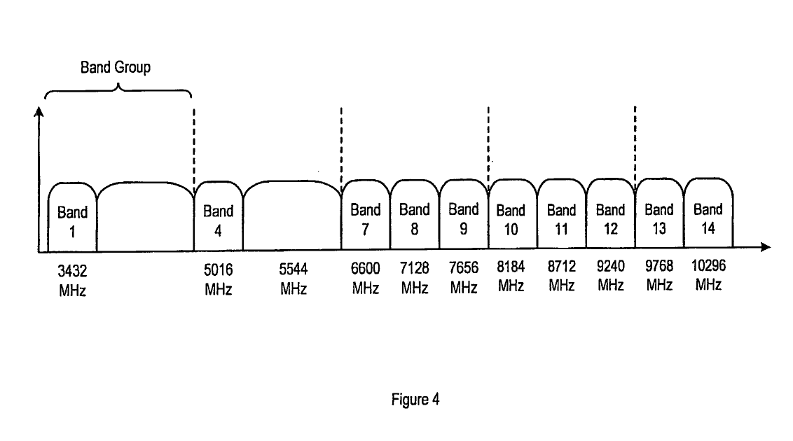

Referring to FIG. 4, the invention can also make use of band stop or notch filters to concatenate frequency sub-bands from two or more sub-bands that are non-adjacent. For example, the invention can be used to concatenate frequency sub-band 2, sub-band 3, sub-band 5 and sub-band 6. The concatenation of sub-bands can also take place between non-adjacent band groups.

It will be appreciated therefore that, rather than the transmitter 109 securing one UWB sub-band for communicating with a second device in the conventional manner, the invention adapts the operation of the transmitter 109 such that it appears that multiple transmitting devices are communicating in parallel. Normally, this would have a degrading impact on other UWB devices operating in the vicinity, because the multiple sub-bands would be employed by the same transmitting device. However, because the UWB transmission is performed over a very small distance (less than 100 cm), or even touching without electrical contact, the first and second devices are able to temporarily fully occupy a plurality of UWB bands in the vicinity, without having a degrading effect on the ability of other devices to use the UWB space. Preferably, the first and second devices temporarily fully occupy most, if not all, of the available UWB bands, adjacent within a band group or channel.

As mentioned above, although the preferred embodiment is adapted to concatenate one or more adjacent sub-bands from within the same band group or channel (for example sub-bands 1 to 3 in the first band group), the invention may also be extended to concatenating UWB bands from more than one band group. Also, although the preferred embodiment discloses that three sub-bands are concatenated, it will be appreciated that any number of sub-bands can be concatenated, including all fourteen sub-bands.

Preferably, to ease integration with existing systems, the concatenated bands are adjacent to one another since the receiver 113 in the second device 105 will be tuned to search for the 1584 MHz spread with time interleaving frequency hopping (time-frequency codes) of existing hardware specifications. However, rather than processing a 528 MHz wide signal as carried out in a conventional receiver, the second device 105 is configured to process a 1584 MHz wide signal.

As mentioned above, the data transfer takes place while the first communication device 103 and the second device 105 are located in a predetermined positional relationship with one another, and preferably in contact with each other (without electrical connection). The use of multiple UWB bands and the reduction in the transmission distance enable a large data file, for example a 10 GB data file relating to a movie, to be transmitted between the first and second devices in less than 1 minute.

According to a further aspect of the invention, the first device 103 is adapted to concatenate two or more sub-bands after the first device has determined how many frequency sub-bands are available for transmission in the area concerned.

The second device 105 is adapted to receive the concatenated sub-bands, and to decode the data from the wider bandwidth baseband signal, for playback or storage in the second device 105. Preferably, the second device is switchable between a first mode of operation in which the receiver is adapted to receive and process a 528 MHz wide signal in a conventional manner, and a second mode of operation in which the receiver is adapted to receive and process a 1584 MHz wide signal in an enhanced data rate mode.

It is noted that the memory 107 for storing data can either form part of the first communication device 103, or be located at a remote connection, for example a central server device. Alternatively, the memory 107 may be split between the first communication device 103 and a separate remote location. For example, a memory 107 within the first communication device 103 could be used to store data that is frequently required (such as the latest popular movies), and the remote memory used to store data that is required less frequently (such as a back catalogue of old movies). Preferably, with this split-storage embodiment the data link between the memory in the first device and the memory in the remote location is very fast, for example a single or plurality of fast copper or fibre channels, such that the data transfer speeds for files stored in the remote location is not too slow.

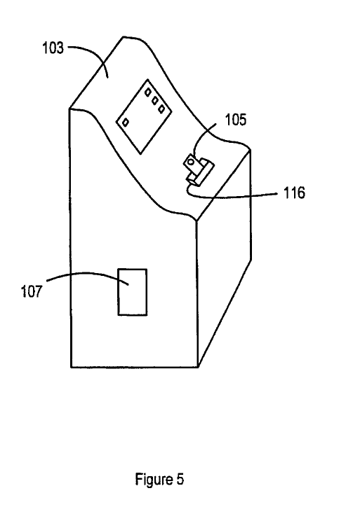

FIG. 5 shows a further aspect of the invention, in which the first communication device 103 comprises a cradle 116 for supporting the second device 105 during the data transfer process. The first communication device 103 is shown as a kiosk, such as an automatic teller machine (ATM) or a petrol pump, for transferring data to the second device 105, such as a portable media player or a portable storage device. As with FIG. 2, the first device 103 comprises a memory device 107 for storing data that is to be downloaded to the second device 105.

According to this embodiment, the cradle 116 acts to support the second device 105 during the data transfer process, and for ensuring that the first and second devices are located in a predetermined positional relationship with one another during the data transfer process. For example, the cradle can be configured to position the first and second devices so that they are less than a predetermined distance apart, for example less than 30 cm apart. Alternatively, the cradle can be configured such that the first and second devices are in physical, but not electrical, contact with one another during the data transfer operation.

This defined proximity permits automatic power control over the wireless interface. For example, the power may be reduced whilst maintaining channel throughput, ultimately enabling a higher density of kiosk installations. In addition, the predetermined positional relationship results in fewer data error correction operations being performed, hence contributing to the increased data transfer rate between the first and second devices.

Although FIG. 5 has been shown as an ATM type machine, it is noted that the cradle 116 could form part of any desktop device (for example part of a computer, DVD player, television or the like), or an independent cradle that is remotely connected to such a device. According to the latter, the cradle houses the transmitter and/or receiver circuitry, and is permanently connected by wire or fibre, or other data channel, to a host device, and accepts the portable device during a data transfer operation.

According to another embodiment, the first communication device 103 can comprise a simple support, for example a pad, for receiving a portable device placed by a user during a data transfer operation. In such an arrangement the support is arranged substantially horizontal, such that the user can simply place the portable device on the support during the data transfer operation. Alternatively, the support can be positioned in some other configuration, such as vertically or sloped, such that the portable device is held by a user against the support during a data transfer operation.

According to yet another embodiment, the first communication device comprises a receptacle or slot into which the portable device slides (without electrical contact).

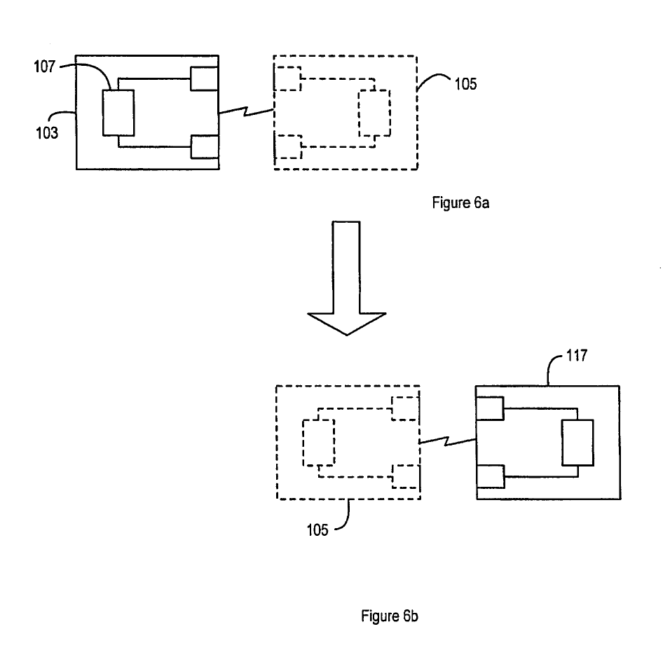

FIGS. 6a and 6b show a typical application of the present invention. In FIG. 6a a first device 103 stores a catalogue of media files in its memory device 107. The first device 103 could be a kiosk vending machine or ATM type machine located in a convenient public place, such as a shopping mall or a fuel pump at a garage forecourt. A user places a portable device 105 in close proximity to the host device 103 in order to select and download a media file, for example a movie. Once the media file has been saved in the memory 106 of the portable device 105, the media can either be played on that device, or transferred to another device, as shown in FIG. 6b. FIG. 6b shows how the media file stored in the memory 106 of the portable device 105 can be uploaded to another device 117, such as a DVD player, PC, television, etc.

As can be seen from the above, the invention enables a user to carry a personal media player having a high-speed UWB chipset integrated, which is capable of playing a variety of media types e.g. music and video streams. The user can download data, including a large video data file, without spending a large amount of time at the vending machine. The portable device is then able to play the media in a portable mode, or even use UWB functionality to stream the high-definition sound or video content onto an UWB enabled television or plasma screen, in what is termed a “docked” configuration. It will be appreciated that in the latter, the portable media player and the UWB enabled television or plasma screen must be in close proximity during the data transfer, if data transfer speed is a priority. If not, for example because the video data is merely being watched on the television or plasma screen, then the portable media player could be configured to transfer data to the other device 117 in a conventional or enhanced data-throughput mode, UWB manner, over greater distances.

The invention is particularly suited for a number of applications where high-speed, short time-span data burst communication is desired. For example, if used in the DVD/music rental business, the shop floor could be cleared of bulky DVD media and cases, and even of counter staff. The invention enables DVD/music rental to be conducted in an un-manned environment, such as a system that is more like an ATM cashpoint system. In other words, a user would be able to walk-in and choose music or film media from one the ATM-style jukeboxes and download their selections in a short space of time to their portable media device. High speed bulk data transfer is important in such an application, since a user does not wish to spend a disproportionate amount of time at the source machine. The invention enables a typical movie to be downloaded in the time a user would normally spend at an existing ATM cash dispenser, which would be acceptable to a user.

Another envisaged application is a “pod-cast” type application, whereby customers could access a Wi-Fi type ultra-wideband hotspot before boarding a train or airplane, enabling them to make selections of media (music, film, or even radio broadcasts) to last the duration of travel.

It is noted that, although the preferred embodiment has been described in relation to the first device being typically a host or server device, it will be appreciated that the first device could also be a portable or hand-held device. In such an arrangement, the invention can be used to transfer data at high speeds between two portable or storage devices.

Also, although the means for positioning the first device and the second device in a fixed positional relationship during a data transfer operation has been described in the preferred embodiment as comprising a cradle for receiving the second device, the positioning means could also comprise a surface for supporting the second device in a fixed relationship to the first device. The surface could either be a surface on which a user places the portable device during a data transfer operation, or a surface which the user holds the portable device against during the data transfer operation.

Furthermore, although the preferred embodiments have been described in relation to the MB-OFDM technique, it will be appreciated that the invention is equally applicable to other ultra-wideband techniques.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A communication device for transmitting a data file to a portable device over an ultra-wideband communication system using multi-band orthogonal frequency division multiplexing, the multi-band orthogonal frequency division multiplexing organised as a plurality of frequency sub-bands, the communication device comprising:
means for concatenating two or more frequency sub-bands during a data transfer operation,
means for transmitting data via the two or more concatenated frequency sub-bands to the portable device; and
means for enabling the portable device to be located in a predetermined positional relationship with respect to the communication device during a data transfer operation.

2. A communication device as claimed in claim 1, wherein the means for positioning is configured to position the portable device within a distance of less than 100 cm to the communication device during the data transfer operation.

3. A communication device as claimed in claim 1, wherein the means for positioning is configured to position the portable device within a distance of less than 30 cm to the communication device during the data transfer operation.

4. A communication device as claimed in claim 1, wherein the means for positioning is configured to place the portable device in contact with, but not electrically connected to, the communication device during the data transfer operation.

5. A communication device as claimed in claim 1, wherein the means for positioning comprises means for retaining the portable device in the fixed positional relationship during a data transfer operation.

6. A communication device as claimed in claim 1, wherein the means for positioning comprises a cradle for receiving the portable device during a data transfer operation.

7. A communication device as claimed in claim 1, wherein the means for positioning comprises a surface for receiving the portable device during a data transfer operation.

8. A communication device as claimed in claim 7, wherein the surface is configured to receive a portable device placed by a user during a data transfer operation.

9. A communication device as claimed in claim 7, wherein the surface is configured to receive a portable device held by a user against or near the surface during a data transfer operation.

10. A communication device as claimed in claim 1, wherein the means for positioning comprises a receptacle or slot into which the portable device slides without electrical connection.

11. A communication device as claimed in claim 1, wherein the means for concatenating is adapted to concatenate two or more adjacent frequency sub-bands during a data transfer operation.

12. A communication device as claimed in claim 11, wherein the means for concatenating is adapted to concatenate two or more adjacent frequency sub-bands from within the same band group of the multi-band orthogonal frequency division multiplexing system during a data transfer operation.

13. A communication device as claimed in claim 1, further comprising means for adapting one or more transmission parameters based on the known positional relationship between the communication device and the second device.

14. A communication device as claimed in claim 1, wherein the communication device is a server device.

15. A method of transmitting a data file between a communication device and a portable device in an ultra-wideband communication system using multi-band orthogonal frequency division multiplexing, the multi-band orthogonal frequency division multiplexing system organised into a plurality of frequency sub-bands, method comprising the steps of:
concatenating two or more frequency bands;
transmitting data via the two or more concatenated frequency bands to the portable device; and
positioning the portable device in a predetermined positional relationship to the communication device during the data transfer operation.

16. A method as claimed in claim 15, wherein the step of positioning comprises positioning the portable device within a distance of less than 100 cm to the communication device during the data transfer operation.

17. A method as claimed in claim 15 wherein the step of positioning comprises positioning the portable device within a distance of less than 30 cm to the communication device during the data transfer operation.

18. A method as claimed in claim 15, wherein the step of positioning comprises placing the portable device in contact with, but not electrically connected to, the communication device during the data transfer operation.

19. A method as claimed in claim 15, wherein the step of positioning comprises providing means for retaining the portable device in the fixed positional relationship during a data transfer operation.

20. A method as claimed in claim 15, wherein the step of positioning comprises providing a cradle for receiving the portable device during a data transfer operation.

21. A method as claimed in claim 15, wherein the step of positioning comprises providing a support surface for receiving the portable device during a data transfer operation.

22. A method as claimed in claim 21 wherein, during use, the portable device is placed by a user on the support surface during the data transfer operation.

23. A method as claimed in claim 21 wherein, during use, the portable device is held against or near the support surface by a user during a data transfer operation.

24. A method as claimed in claim 15, wherein the step of positioning comprises providing a receptacle or slot into which the portable device slides without electrical contact during a data transfer operation.

25. A method as claimed in claim 15, wherein the step of concatenating comprises the step of concatenating two or more adjacent frequency sub-bands during a data transfer operation.

26. A method as claimed in claim 25, wherein the step of concatenating comprises the step of concatenating two or more adjacent frequency sub-bands from within the same band group of the multi-band orthogonal frequency division multiplexing system during a data transfer operation.

27. A method as claimed in claim 15, wherein the communication device is a server device.

28. A portable device for use with a communication device as defined in claim 1, the portable device comprising:
a receiver for receiving a signal comprising two or more concatenated frequency sub-bands; and
processing means for processing the concatenated sub-bands.

29. A portable device as claimed in claim 28, wherein the receiver is switchable between a first mode of operation in which the receiver is adapted to receive and process the two or more concatenated frequency sub-bands, and a second mode of operation in which the receiver is adapted to receive and process a single frequency sub-band.

30. A communication device for transmitting a data file to a portable device over an ultra-wideband communication system using multi-band orthogonal frequency division multiplexing, the multi-band orthogonal frequency division multiplexing organised as a plurality of frequency sub-bands, the communication device comprising:
a transmitter configured to concatenate two or more frequency sub-bands during a data transfer operation and to transmit data via the two or more concatenated frequency sub-bands to the portable device; and
a support member configured to position the portable device in a predetermined positional relationship with respect to the communication device during a data transfer operation.

31. A communication device as claimed in claim 30, wherein the support member is configured to position the portable device within a distance of less than 100 cm to the communication device during the data transfer operation.

32. A communication device as claimed in claim 30, wherein the support member is configured to position the portable device within a distance of less than 30 cm to the communication device during the data transfer operation.

33. A communication device as claimed in claim 30, wherein the support member is configured to place the portable device in contact with, but not electrically connected to, the communication device during the data transfer operation.

34. A communication device as claimed in claim 30, wherein the support member comprises a cradle for receiving the portable device during a data transfer operation.

35. A communication device as claimed in claim 30, wherein the support member is configured to receive a portable device placed by a user during a data transfer operation.

36. A communication device as claimed in claim 30, wherein the support member is configured to receive a portable device held by a user against or near the support member during a data transfer operation.

37. A communication device as claimed in claim 30, wherein the support member comprises a receptacle or slot into which the portable device slides without electrical connection.

38. A communication device as claimed in claim 30, wherein the transmitter is adapted to concatenate two or more adjacent frequency sub-bands during a data transfer operation.

39. A communication device as claimed in claim 38, wherein the transmitter is adapted to concatenate two or more adjacent frequency sub-bands from within the same band group of the multi-band orthogonal frequency division multiplexing system during a data transfer operation.

40. A communication device as claimed in claim 30, wherein the transmitter is configured to adapt one or more transmission parameters based on the known positional relationship between the communication device and the second device.

41. A communication device as claimed in claim 30, wherein the communication device is a server device.
